(19) United States
(12) Patent Application Publication
(10) Pub. No.: US 2013/0214052 A1
(43) Pub. Date: Aug. 22, 2013

(54) EASY-T0-ADJUST WATER HEATER

(71) Applicant: Dingwu Yang, Zhuahai City (CN)

(72) Inventor: Dingwu Yang, Zhuahai City (CN)

(73) Assignee: ZHUHAI RUNXINGTAI ELECTRICAL EQUIPMENT CO. LTD., Zhuhai City (CN)

(21) Appl. No.: 13/525,482

(22) Filed: Jun. 18, 2012

(30) Foreign Application Priority Data
Feb. 22, 2012 (CN) 201220058252.6

(51) Int. Cl. G05D 23/00

(52) U.S. Cl. 236/20 R

(57) ABSTRACT

The present invention discloses an easy-to-adjust water heater, which comprises a body provided with a heating device, and a wired control box connected with the body through wire for controlling the working state of the heating device; the wired control box is provided with a temperature increasing button, a temperature decreasing button and a water heater switch button on the surface thereof. The wired control box of the water heater according to the present invention is configured outside the body of the water heater via a wire connection, and used to control the working state of the heating device within the water heater. In use, the wired control box may be disposed within the bathroom, while the water heater may be disposed in a drier place outside the bathroom, the advantage of the present invention lies in allowing the user to adjust the water temperature conveniently during shower with the water heater, at the same time avoiding the use of the water heater in a wet environment.

### TECHNICAL FIELD

The present invention relates to a water heater, and more particularly to an easy-to-adjust water heater.

### BACKGROUND INFORMATION

As common apparatuses for heating water, water heaters are well known and widely used. Usually, the water heaters are installed in bathroom for users' convenience. The conventional water heaters heat up the cold water exploiting gas as energy source, however, as heating with gas, there exist inconveniences. In detail, on one hand after a period of use, the gas-jar must be replaced as the gas therein runs out; on the other hand, as the gas-jar usually has a large volume, and thus requires a special place for placing the gas-jar, lots of space is occupied.

At present lots of common water heaters use electricity power as energy source. However, as described above the water heaters are usually installed in bathroom, in which the air is humid; the service life of the water heaters will be significantly reduced as their heating circuits will be damaged soon while operating in a humid environment. Resulting from above, users tend to install the water heaters outside the bathroom, but this may cause inconvenience for users in, for example, adjusting the water temperature during bathing.

### THE SUMMARY OF THE INVENTION

In order to overcome the defects of the existing technology, the present invention provides an easy-to-adjust water heater. The technical solution of the present invention for solving the technical problem thereof may be described as follows:

An easy-to-adjust water heater, characterized in that: the water heater comprises a body provided with a heating device, and a wired control box connected with the body through wire for controlling the working state of the heating device; the wired control box is provided with a temperature increasing button, a temperature decreasing button, and a water heater switch button.

The body is provided with a heating channel within, one end of the heating channel is configured in a water entry, while the other end is configured in a water exit; the heating channel is provided with at least one heating pipe therein, and an incoming water temperature sensor, a flow sensor, an outgoing water temperature sensor and a temperature controller for adjusting the working state of the heating pipe thereon; the temperature controller is connected with the incoming water temperature sensor, the flow sensor, the outgoing water temperature sensor and the heating pipe respectively.

The heating channel comprises a water inlet curve, and several heating cups interconnected in series and connected to the water inlet curve, each heating cup is provided with a heating pipe therein.

The wired control box is provided with a display screen for displaying the temperature of the outgoing water on the surface thereof.

The housing is provided with a display panel for displaying the temperature of the outgoing water on the surface thereof.

The beneficial effects of the present invention include: the water heater of the present invention comprises a wired control box which is configured outside the body of the water heater via a wire connection, and the working state of the heating device is controlled by the wired control box, thus in use, the wired control box may be disposed within the bathroom, while the body of the water heater may be disposed in a drier place outside the bathroom, the advantage of such a configuration lies in allowing the user to adjust the water temperature conveniently during shower using the water heater within the bathroom, at the same time avoiding the use of the water heater in a wet environment.

### BRIEF DESCRIPTION OF THE DRAWINGS

Further details and advantages of the present invention are explained using an embodiment, with reference to the attached drawings. In the drawings:

FIG. 1 is a schematic view showing the installation and use of the present invention;

FIG. 2 is an exploded view showing the interior of the body of the water heater of the present invention;

FIG. 3 is schematic view showing the surface of the wired control box of the present invention.

### EMBODIMENTS

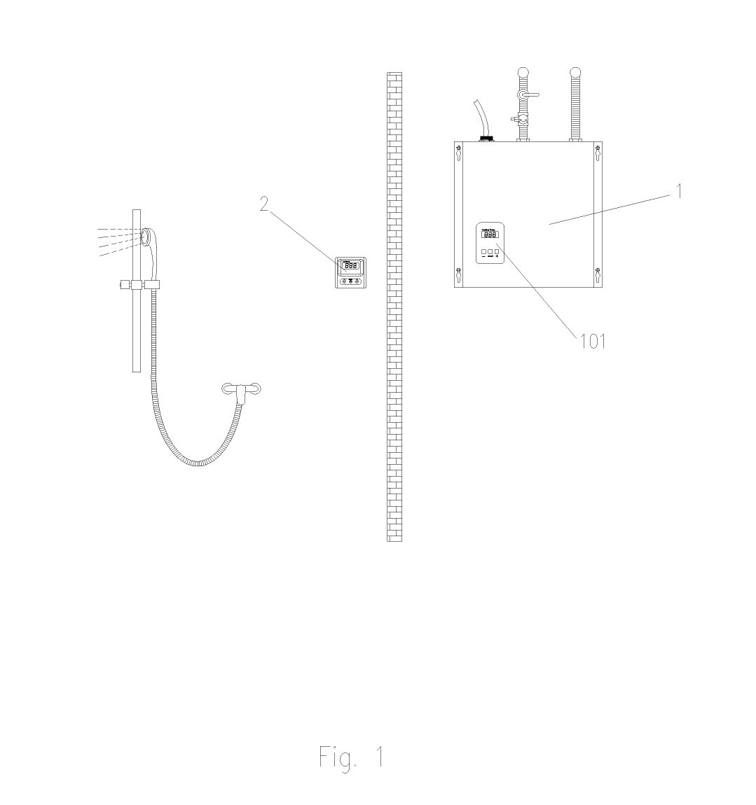

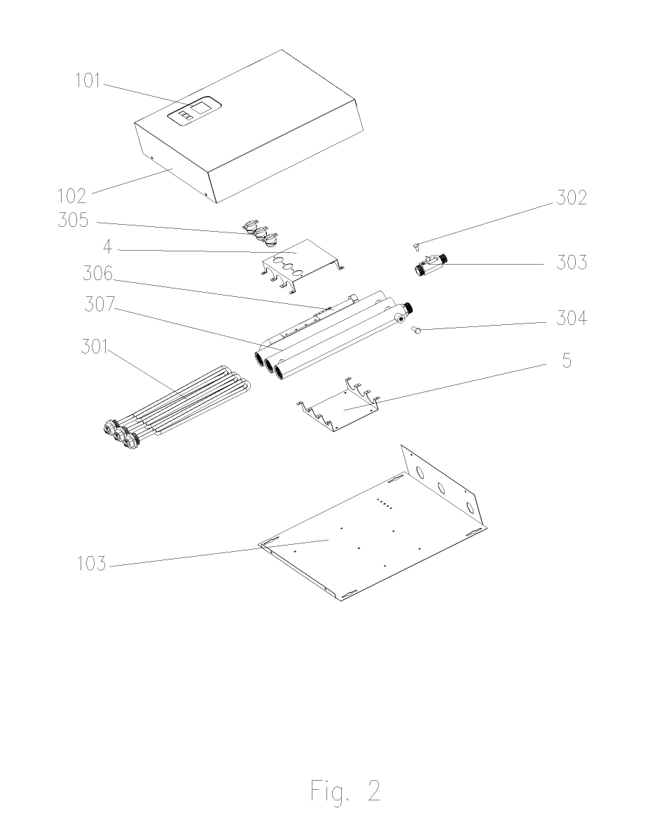

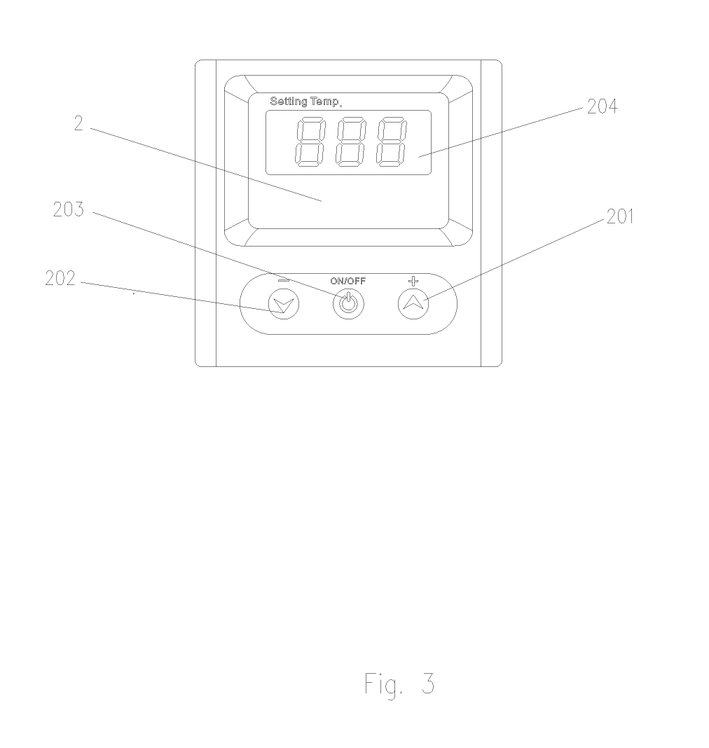

As shown in FIG. 1-3, an easy-to-adjust water heater disclosed by the present invention comprises a body 1 which is provided with a heating device, and a wired control box 2 which is connected to the housing through wired and used to control the working state of the heating device. In the embodiment shown in the drawings, in order to facilitate the installation and uninstallation of the water heater, the body 1 consists of a front housing 102 and a back housing 103, which are assembled by way of clamping and made of sheet material. The wired control box 2 is provided with a temperature increasing button 201, a temperature decreasing button 202 and a water heater switch button 203. In installation, the wired control box 2 may be mounted within the bathroom, while the body 1 may be mounted in a dry place outside the bathroom, so as to allow a user in shower to adjust the water temperature through the temperature increasing button 201 or the temperature decreasing button 202, conveniently.

In a preferred embodiment of the technical solution described above, the body 1 is provided with a heating channel, of which one end is configured in a water entry, and the other end is configured in a water exit. Within the water channel, heating pipes 301 are disposed. In addition, on the water channel an incoming water temperature sensor 302, a flow sensor 303, an outgoing water temperature 304, and a temperature controller 305 for controlling the working state of the heating pipes 301 are provided, wherein, the temperature controller 304 is connected with the incoming water temperature sensor 302, flow sensor 303, outgoing water temperature 304 and heating pipes 301 respectively. The heating channel further comprises a water inlet curve 306, and three heating cups 307 interconnected in series and connected with the water inlet curve 306, wherein in each heating cup a heating pipe 301 is disposed. The temperature controller 305 is mounted above the heating cups 307 via an upper support 4 and a lower support 5 matched.

In another preferred embodiment of the technical solution described above, the wired control box 2 is provided with a display screen 204 disposed on the surface thereof for displaying the outgoing water temperature; in a similar way the body 1 is provided with a display panel 101 on the surface thereof for displaying the outgoing water temperature.

While the invention has been described in terms of what are presently considered to be the most practical and preferred embodiments, it is to be understood that the invention need not be limited to the disclosed embodiments. On the contrary, it is intended to cover various modifications and similar arrangements included within the spirit and scope of the appended claims which are to be accorded with the broadest interpretation so as to encompass all such modifications and similar structure.

What is claimed is:

1. An easy-to-adjust water heater comprising:
a body, said body having a heating device and a wired control box electrically coupled with said body via one or more wires, said wired control box for controlling the working state of the heating device;
wherein said wired control box comprises:
a temperature increasing button;
a temperature decreasing button; and
a water heater switch button.

2. The water heater according to claim 1, wherein said body additionally comprises:
a heating channel, wherein one end of said heating channel is configured in a water entry and the other end of said heating channel is configured in a water exit;
wherein said heating channel comprises:
at least one heating pipe;
an incoming water temperature sensor; a flow sensor;
an outgoing water temperature sensor; and
a temperature controller for adjusting the working state of said heating pipe;
wherein said temperature controller is connected with said incoming water temperature sensor, the flow sensor, the outgoing water temperature sensor and the heating pipe.

3. The water heater according to claim 2, wherein the heating channel comprises:
a water inlet curve and a plurality of heating cups interconnected in series and connected to said water inlet curve, wherein each heating cup is provided with a heating pipe.

4. The water heater according to claim 1, wherein said wired control box additionally comprises a display screen, said display screen capable of displaying the temperature of the outgoing water.

5. The water heater according to claim 1, wherein said body additionally comprises a display panel, said display panel capable of displaying the temperature of the outgoing water.

6. The water heater according to claim 2, wherein said wired control box additionally comprises a display screen, said display screen capable of displaying the temperature of the outgoing water.

7. The water heater according to claim 2, wherein said body additionally comprises a display panel, said display panel capable of displaying the temperature of the outgoing water.
